(19) United States
(12) Patent Application Publication
(10) Pub. No.: US 2005/0241703 A1
(43) Pub. Date: Nov. 3, 2005

(54) Single piece, multi-port precision valve

(75) Inventor: Stephen J. Takacs, Evans, CO (US)

Correspondence Address: SETTER OLLILA, LLC, 2060 BROADWAY, SUITE 300, BOULDER, CO, 80302, US

(73) Assignee: HACH COMPANY

(21) Appl. No.: 10/953,741

(22) Filed: Sep. 29, 2004

Related U.S. Application Data
(60) Provisional application No. 60/566,247, filed on Apr. 28, 2004.

(51) Int. Cl. F16K 11/085

(52) U.S. Cl. 137/625.46

(57) ABSTRACT

A multi-port precision valve with a rotor having the valve face moved to a chamfered surface. The chamfered valve face makes an angle with respect to the axis of rotation of the rotor. The exit ports make an angle with respect to the valve face of between 70 and 90 degrees.

### RELATED APPLICATIONS

This application claims the benefit of U.S. provisional application No. 60/566,247 filed on Apr. 28, 2004 entitled “A Single Piece, Multi-Port Precision Valve,” which hereby is incorporated by reference into this application.

### BACKGROUND OF THE INVENTION

1. Field of the Invention

The invention is related to precision valves, and in particular, to a single piece, multi-port precision valve.

2. Statement of the Problem

Current multi-port precision valves have a number of problems. One problem is that many valves have the ports configured to exit the valve body horizontally (see FIG. 1). This makes it difficult to access the ports. Designs with angled ports typically use additional parts to allow the ports to be tilted (see FIG. 9).

Therefore there is a need for a one piece easy to use multi-port valve.

### SUMMARY OF THE INVENTION

A multi-port precision valve with a rotor having the valve face moved to a chamfered surface. The chamfered valve face makes an angle with respect to the axis of rotation of the rotor. The exit ports make an angle with respect to the valve face of between 70 and 90 degrees.

### BRIEF DESCRIPTION OF THE DRAWINGS

FIG. 1 illustrates a prior art multi-port precision valve with horizontal exit ports.

FIG. 2 is an assembly drawing of a multi-port valve in an example embodiment of the invention.

FIG. 3 is a drawing of a valve rotor in an example embodiment of the invention.

FIG. 4 is a drawing of a valve body in an example embodiment of the invention.

FIG. 5 is a sectional view of a valve body in an example embodiment of the invention.

FIG. 6 illustrates the flow in the 2 positions for a 6 port 2 position valve.

FIG. 7 is a drawing of a prior art rotor where the valve face is on the generally cylindrical surface.

FIG. 8 is a table of tested flow parameters for one example embodiment of the invention.

FIG. 9 is a drawing of a prior art valve where the valve face is on the end of the rotor.

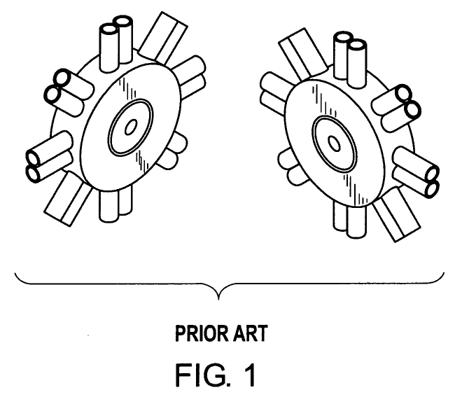

### DETAILED DESCRIPTION OF THE PREFERRED EMBODIMENT

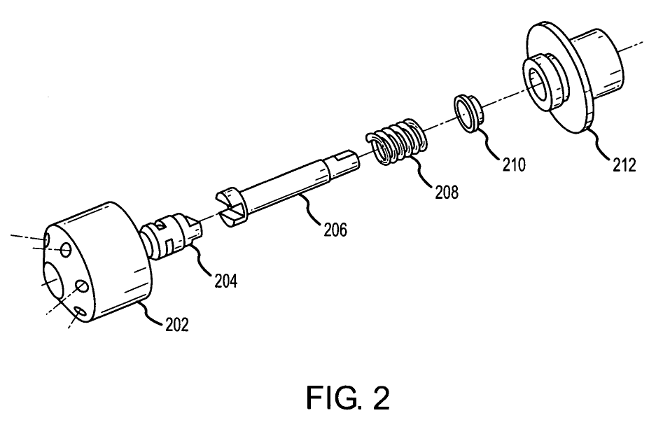

FIGS. 2-6 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 2 is an assembly drawing of a multi-port precision valve in an example embodiment of the current invention. The multi-port precision valve is comprised of a valve body (202), a valve rotor (204), a valve stem (206), a valve spring (208), a valve bushing (210), and a valve housing (212). The valve body (202) is also sometimes called a valve stator. FIG. 2 is an example embodiment of the invention showing a 6 port, 2 position multi-port precision valve. In one example embodiment the valve body is made from PEEK and the valve rotor is made from Teflon.

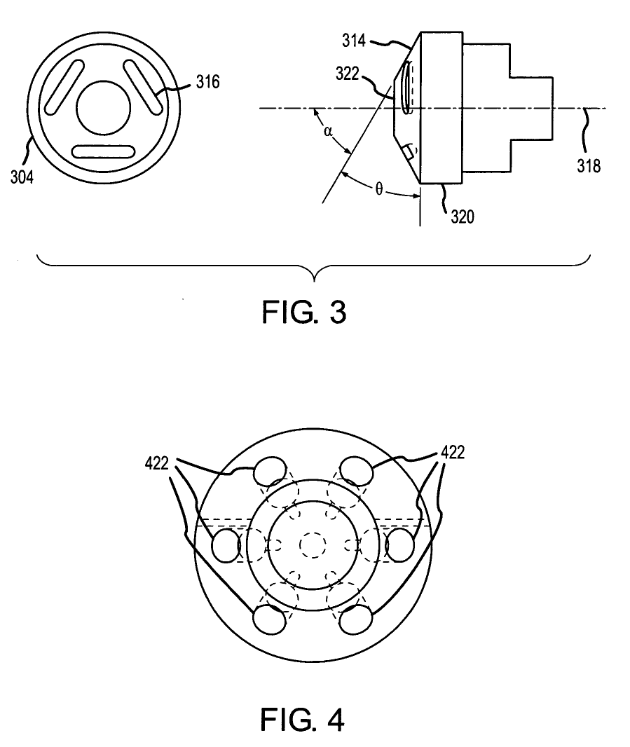

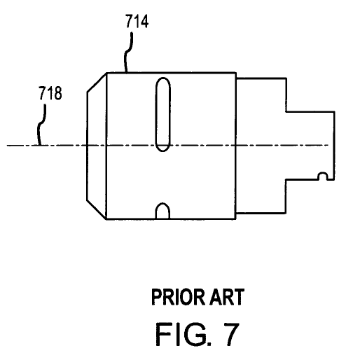

FIG. 3 is a drawing of a valve rotor (304) in an example embodiment of the invention. The side-view of FIG. 3 shows an axis of rotation (318) for the valve rotor. In one example embodiment, the valve rotor has a cylindrical section (320) where the cylindrical axis corresponds to the axis of rotation. Valve face (314) makes an angle θ with respect to a plane perpendicular to the axis of rotation (318). In prior art rotors, the valve face would typically be the surface of the cylindrical portion of the rotor (714) or the face of the rotor (922). In the current invention, the valve face has been moved to the chamfered surface (314). In a preferred embodiment the chamfered angle θ is approximately 30 degrees. The angle made by the valve face with respect to the axis of rotation (318) is α. The angle α is equal to 90−θ. In prior art valves, when the valve face was on the generally cylindrical section of the rotor body, the generally cylindrical section may have had a small angle that was typically around 1.5 degrees (see FIG. 7). In a preferred embodiment of the current invention, the angle α is approximately 60 degrees (90−30=60). Other embodiments are envisioned where the angle α is between 15 and 75 degrees. The chamfered or conical valve face has a truncated top to lower the height of the valve and to ensure contact to the mating part (discussed below). In other configuration the valve face could have a rounded top (not shown), or the valve face could end in a point (not shown).

Channels (316) or slots are formed in the valve face (314). The channels (316) are spaced symmetrically around the axis of rotation (318). In one example embodiment the channels (316) are straight slots in the valve face (314). In another embodiment of the invention the channels are formed along a radius (not shown) centered on the axis of rotation (318). Other channels shapes are possible.

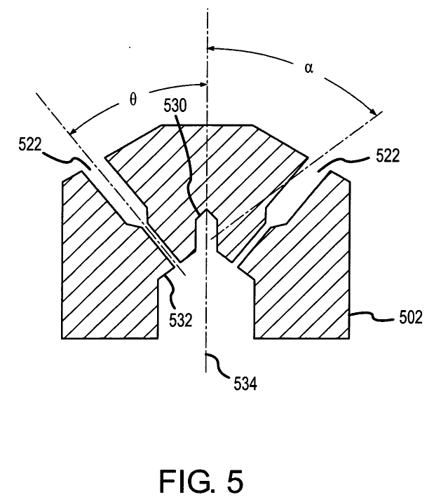

FIG. 4 is a drawing of a valve body in an example embodiment of the invention. In this embodiment there are 6 ports (422) spaced symmetrically around the valve body. In a 2 position valve there is typically an even number of ports, for example 6 or 10 ports. FIG. 5 is an enlarged and simplified sectional view of a valve body in an example embodiment of the invention. The valve body (502) has a valve surface (532) that the valve face (314) mates against. The valve surface (532) makes the same angle α that valve face (314) makes with respect to an axis of rotation (534). In operation, the valve face (314) of the valve rotor (104) engages the valve surface (532) of the valve body (502). The valve body (502) may have a relief (530) at the center of valve surface to ensure that the contact between the valve surface (532) and the valve face (314) is not preempted by contact at or near the tip of the valve face. The valve body has a plurality of ports (522). The ports (522) are spaced evenly around the valve body. The ports (522) intersect the valve surface (532). The centerline of the ports makes an angle Φ with respect to the axis of rotation 534. In a preferred embodiment the angle Φ is equal to the angle α causing the port centerline to be perpendicular to the valve surface (532) at the point of intersection. Other angles are envisioned. The angle Φ can vary from the angle α by as much as plus or minus 20 degrees.

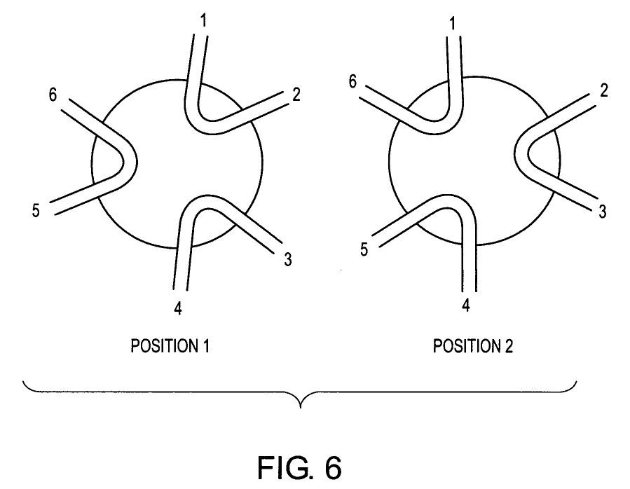

In operation, when the valve rotor is engaged with the valve body (see sectional view BB of FIG. 2), valve surface is in contact with valve face. The channels in the valve face are configured to connect two ports of the six ports in the valve. In a first position of the valve rotor, the channels in the valve face of the valve rotor connect ports 1 and 2, ports 3 and 4, and ports 5 and 6 (see FIG. 6a). In a second position of the valve rotor, the channels in the valve face connect ports 2 and 3, ports 4 and 5, and ports 6 and 1 (see FIG. 6b). As the valve rotor rotates around the axis of rotation, the valve switches between the 2 positions shown in FIGS. 6a and 6b. For a 6 port 2 position valve, there are 3 channels. The number of channels typically increase as the number of ports increase. This invention is described using a 6-port, 2 position valve as an example. But the invention is not limited to 2 position valves, other valve configurations may be used, for example multi-port stream selectors or distribution valves.

In prior art rotors (see FIG. 7), with the valve face on the side of the rotor, the angle of the valve face (714) with respect to the axis of rotation (718) is only 1.5 degrees. With such a small angle, a stiff spring is required to produce an appropriate force between the valve face of the valve rotor and the valve surface of the valve body. In one example embodiment of the current invention, with the valve face moved to the chamfered surface, the angle of the valve face with respect to the axis of rotation is approximately 60 degrees. This creates a much higher contact force between the valve face and the valve surface for a given spring stiffness. In the prior art valve rotor, a small mismatch between the angle or diameter of the valve rotor compared to the valve body corresponded to a large displacement of the channels in the valve rotor with respect to the position of the ports in the valve surface. With the current invention, alignment of the channels to the ports is significantly less dependent on matching the angle on the valve face with the angle on the valve surface.

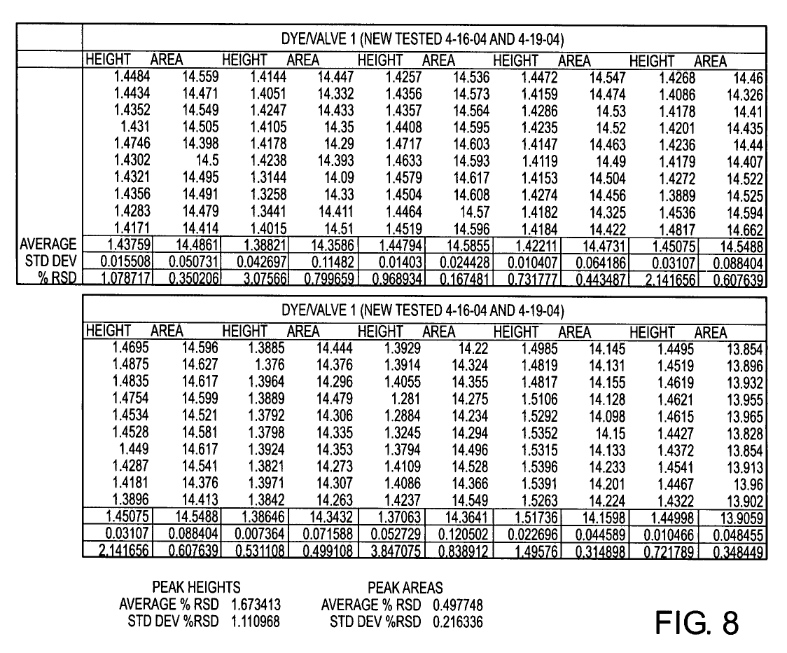

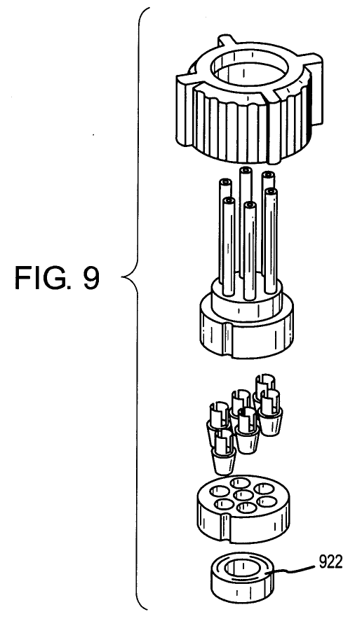

In one example embodiment of the current invention, the accuracy of the valve has been tested. FIG. 8 is a table of the tested flow parameters for one example embodiment of the invention. Each test measures the peek height (or maximum flow rate) and area under the curve (or total volume) for the flow through the valve for a number of cycles (listed in each pair of columns). The test then computes the averages, the standard deviation and the percent relative standard deviation (RSD) for each column. The tests are run multiple times and the average % RSD and standard deviation % RSD for both the height and the area for all the runs are tabulated at the bottom of FIG. 8. For 100 runs the average % RSD was 0.313177.

1. A multi-port valve, comprising:
a cylindrical rotor having a first end and an axis of rotation that corresponds to the cylindrical axis;
a chamfered surface at the first end of the cylindrical rotor forming a valve face;
the valve face having a plurality of channels formed in the valve face where the channels are evenly spaced along a radius of the chamfered surface.

2. The multi-port valve of claim 1 where the valve face forms an angle with respect to the axis of rotation of between 15 and 75 degrees.

3. The multi-port valve of claim 1 where valve face forms an angle with respect to the axis of rotation of approximately 60 degrees.

4. The multi-port valve of claim 1 where the channels are straight slots in the valve face.

5. The multi-port valve of claim 1 where the channels are curved slots following a radius along the valve face.

6. The multi-port valve of claim 1 where the cylindrical rotor is made from Teflon.

7. The multi-port valve of claim 1 where the chamfered surface ends in a rounded tip at the first end of the cylindrical rotor.

8. The multi-port valve of claim 1 where the chamfered surface ends in a point at the first end of the cylindrical rotor.

9. The multi-port valve of claim 1, further comprising:
a valve body having a cylindrical opening, where the cylindrical opening ends in a conically shaped depression, where the surface of the conically shaped depression forms a valve surface;
a plurality of ports passing through the valve body and intersecting the valve surface where the plurality of ports are evenly spaced around a radius of the conical depression and configured to match the position of the plurality of channels in the valve face.

10. The multi-port valve of claim 9 where the plurality of ports intersect the surface of the conical depression at an angle between 70 degrees and 90 degrees.

11. The multi-port valve of claim 9 where the plurality of ports intersect the surface of the conical depression at an angle of approximately 90 degree.

12. The multi-port valve of claim 9 where the conically shaped depression has a hole formed at the vertex of the conically shaped depression such that the chamfered surface of the valve face engages the valve surface without binding at the vertex of the cones.

13. The multi-port valve of claim 9 where the valve body is made from PEEK.

14. A method for manufacturing a multi-port valve, comprising:
forming a rotor having a conical valve face where the conical valve face forms a first angle with respect to an axis of rotation of between 15 and 75 degrees;
forming a valve body having a valve surface that has a correspond conical shape where the valve surfaces mates with the conical valve face;
forming a plurality of ports that penetrate the valve body and intersect with the conical valve surface;
spacing the plurality of ports around the conical valve surface;
forming a plurality of channels spaced around the conical valve faces such that the channels align with the plurality of ports when the valve face is mated to the valve surface.

15. The method of manufacturing a multi-port valve of claim 14 where the valve body is made from PEEK and the rotor is made from Teflon.

16. The method of manufacturing a multi-port valve of claim 111 where the plurality of ports are formed to intersect the valve surface at a second angle and the second angle is in the range from 70 degrees to 90 degrees.

17. A method for using a multi-port valve, comprising:
rotating a conically shaped valve face from a first position to a second position with respect to a correspondingly shaped conical valve surface inside a valve body where the conically shaped valve face forms an angle of between 15 and 75 degrees with respect to the axis of rotation and where there are a plurality of ports that penetrate the valve body and intersect with the conically shaped valve surface and where the plurality of ports are spaced around the conically shaped valve surface and where there are a plurality of channels spaced around the conically shaped valve face such that the channels align with the plurality of ports when the valve face is mated to the valve surface and where a first one of the plurality of channels connect a first port to a second port when the conically shaped valve face is in the first position and where the first one of the plurality of channels connects the second port to a third port when the conically shaped valve face is in the second position.

18. A multi-port valve, comprising:
a valve rotor having a conical valve face where the cone angle is between 30 and 150 degrees;
a valve body having a valve surface where the conical valve face is configured to mate with the vale surface;
a plurality of ports in the valve body intersecting the valve surface;
a means for connecting at least a first port with a second port when the conical valve face is mated with the valve surface and the valve rotor is in a first position.
